(19) United States
(12) Patent Application Publication
(10) Pub. No.: US 2012/0146532 A1
(43) Pub. Date: Jun. 14, 2012

(54) CURRENT REGULATOR CIRCUIT FOR LED LIGHT

(75) Inventors: John Ivey, Farmington Hills, MI (US); Francis Palazzolo, Rochester Hills, MI (US)

(73) Assignee: ALTAIR ENGINEERING, INC., Troy, MI (US)

(21) Appl. No.: 13/315,598

(22) Filed: Dec. 9, 2011

Related U.S. Application Data
(60) Provisional application No. 61/421,347, filed on Dec. 9, 2010.

(51) Int. Cl. H05B 37/02

(52) U.S. Cl. 315/224; 315/307

(57) ABSTRACT

A regulator scheme for an LED light wherein the peak input current to the regulator and the regulator duty cycle produce a feedback signal which infers the average regulator output current. Both buck-boost and flyback type output circuits are disclosed.

### CROSS-REFERENCE TO RELATED APPLICATION

This application claims the benefit of U.S. provisional patent application Ser. No. 61/421,347 filed Dec. 9, 2010.

### BACKGROUND

It is desirable to provide output regulation for LED-based lights used in place of fluorescent lights so as to produce a relatively constant light output in the face of variations in line voltage and/or component values. Typically, this has required the use of high side current sensing, opto-isolators and/or photosensors.

### SUMMARY

A regulator scheme for an LED-based light eliminates the need for high side sensing, opto-isolators, photo detectors, or other connections and electric isolation between regulator input and output in order to maintain a relatively constant light output even though the supply voltage and/or component values may vary somewhat in use.

The peak input current to the regulator switching inductor and the regulator conduction duty cycle are determined and used to produce a feedback signal which is connected to the regulator input. This combination of signals infers the regulator average output current and is used as the input to the LED-based light so as to maintain a substantially constant light level irrespective of variations in input line voltage, or component values.

### BRIEF SUMMARY OF THE DRAWINGS

The description herein makes reference to the accompanying drawings wherein like reference numerals refer to like parts throughout the several views and wherein:

FIG. 1 is a schematic circuit diagram of an illustrative embodiment of the invention using a buck-boost output circuit;

FIG. 2 is a highly simplified schematic circuit diagram helpful in explaining the operation of the circuit of FIG. 1;

FIGS. 3A through 3E are waveform diagrams helpful in discussing the operation of the circuits in FIGS. 1 and 2;

FIG. 4 is an alternative flyback-type output circuit; and

FIG. 5 is an alternative averaging circuit for use where the detector circuit of FIG. 1 operates in a discontinuous mode.

### DETAILED DESCRIPTION

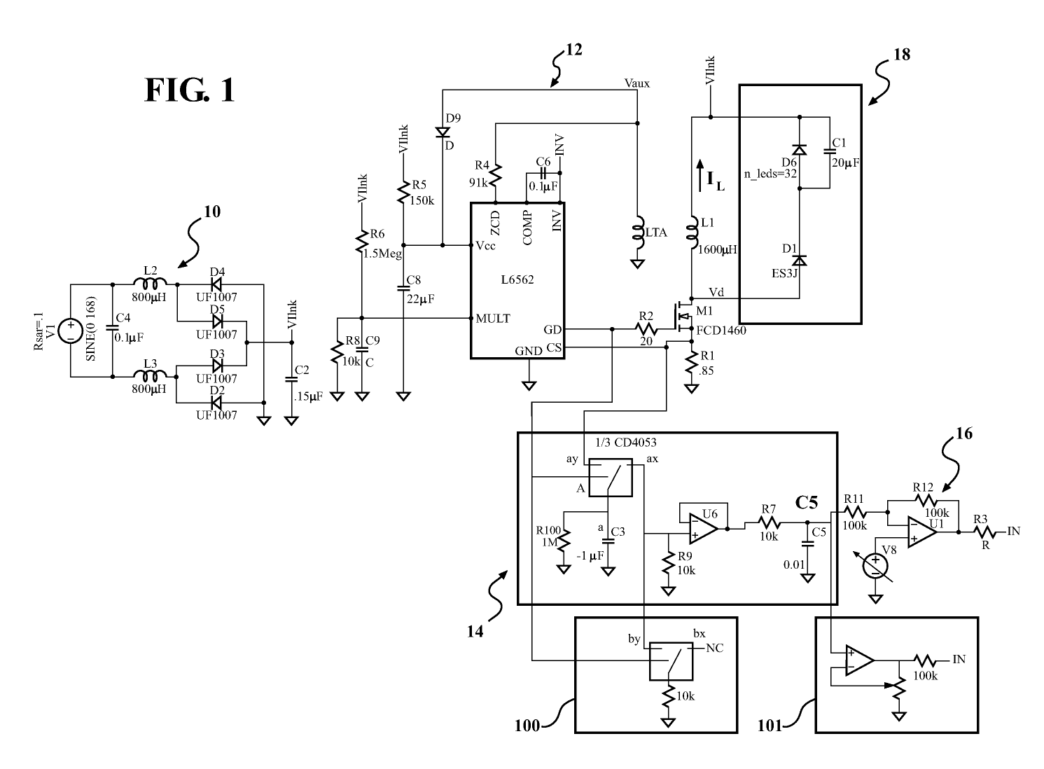

Referring to FIG. 1, the schematic circuit diagram there illustrated includes an input power conditioning circuit 10 adapted to receive, filter and rectify a standard 110V AC input Vi and produce an output Vlink. The filter components C2, C4, L2 and L3 are selected to allow the link voltage to largely follow the AC line voltage as it varies through one 50 or 60 Hz cycle. This allows the regulator circuit L6562 to maintain the instantaneous line current approximately proportional to instantaneous line voltage, thus providing power factor correction to the line. FIG. 1 further comprises a regulator circuit 12, also called a “converter”, labeled to show where Vlink is connected to the inputs Vcc and MULT. FIG. 1 further comprises an output current inference circuit 14, operating as a sample and hold, gating and filtering circuit to produce a signal lout=Ipeak/2 (1-duty cycle). FIG. 1 further comprises an output current set and feedback gain circuit 16, the output INV of which is connected to the INV input on the upper right corner of the regulator circuit L6562; i.e., INV is the feedback signal which is connected back to an input of the regulator circuit L6562 to produce a relatively constant output current.

Finally, FIG. 1 shows an output circuit 18, the principal components of which are an FET switch M1 and a diode D6 which in this case is representative of a bank of light emitting diodes, hereinafter “LEDs” which in this case are deemed to be mounted in a 48-inch tube light used in place of a conventional 48-inch fluorescent light. In such a case, it is important to maintain a relatively constant output intensity, brightness and color irrespective of variations in Vlink. All of the circuits 10, 12, 14, 16 and 18 have components which are individually labeled with values for enablement purposes, it being understood that these values are illustrative rather than limiting.

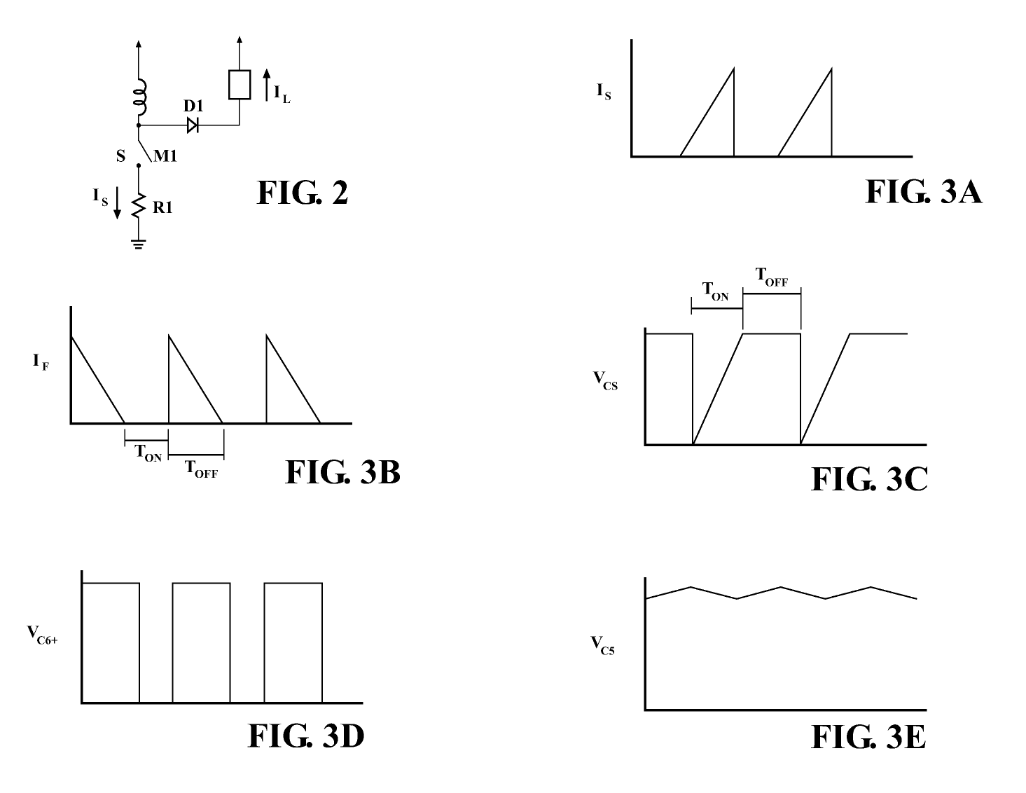

Looking to FIG. 2, the abbreviated circuit there shown includes the inductor L1 which is part of circuit 18, a switch S which is representative of the FET M1, a resistor which is representative of R1, and a diode which is representative of a rectifying diode D1 in circuit 18 and a load which is representative of the LED bank shown at D6 in circuit 18 of FIG. 1.

Referring to FIG. 3, the switch S opens and closes at a frequency much higher than the line voltage frequency. When the switch is closed, the current Iₛ rises as shown in FIG. 3A to produce a periodic triangular waveform having a peak value. When the switch S opens, current from L1 flows through the diode D1 to the load and declines from a peak value to zero as shown in FIG. 3B. In the boundary conduction mode of operation, switch opening occurs when the desired peak inductor current is reached as determined by the feedback circuit and circuits within L6562. Switch closing occurs when the inductor current reaches zero.

The single pole double throw switch ⅓ CD4053 which is part of circuit 14 operates at the same frequency as the FET switch M1. It connects the output of M1 to a capacitor C3 when the switch is connected to ay and then transfers that voltage VC3 to the input U6 of the sample and hold circuit which impresses the voltage across capacitor C5. R100 ensures that the feedback voltage goes to zero when power is disconnected, which is necessary for a proper startup sequence.

Optionally, circuit 100 can be used to replace R9. Circuit 100 comprises a single pole double throw switch and resistor; during the on time of the FET switch, the SPDT switch connects a discharge resistor to ground and to the inverting input of U6. This causes any parasitic capacitance at the non-inverting input of U6 to be discharged during that time, ensuring a zero output. When the FET switch is off, the SPDT switch is open, preventing the voltage from C3 from dropping excessively during this time. VC3 is shown in FIG. 3C. FIG. 3D shows the voltage at ax, the output of the sample and hold switch which is connected as an input to U6. Finally, FIG. 3E shows the average voltage across capacitor C5 which will be directly related to the peak current of FIG. 3B and the duty cycle of FIGS. 3C and 3D. Here “duty cycle” means the proportion of the total cycle time the switch S is open. The voltage across C5 is proportional to (Imax/2)•(Tout/T) where Tout is the conduction time of DI and T is the period. After scaling it to the appropriate level in circuit 16, this becomes the signal INV which, as stated above, is connected to the upper right hand input INV of the regulator circuit L6562. The voltage at C5 is proportional to the LED current. The filter time constant of the low pass filter comprising R7 and C5 is preferably equal to the dynamic resistance (dV/dl) of the LED string at the design output current times the output capacitance (C1). This causes the dynamic response of the voltage on C5 to be the same as that of the LED and C1 combination, giving optimum regulation.

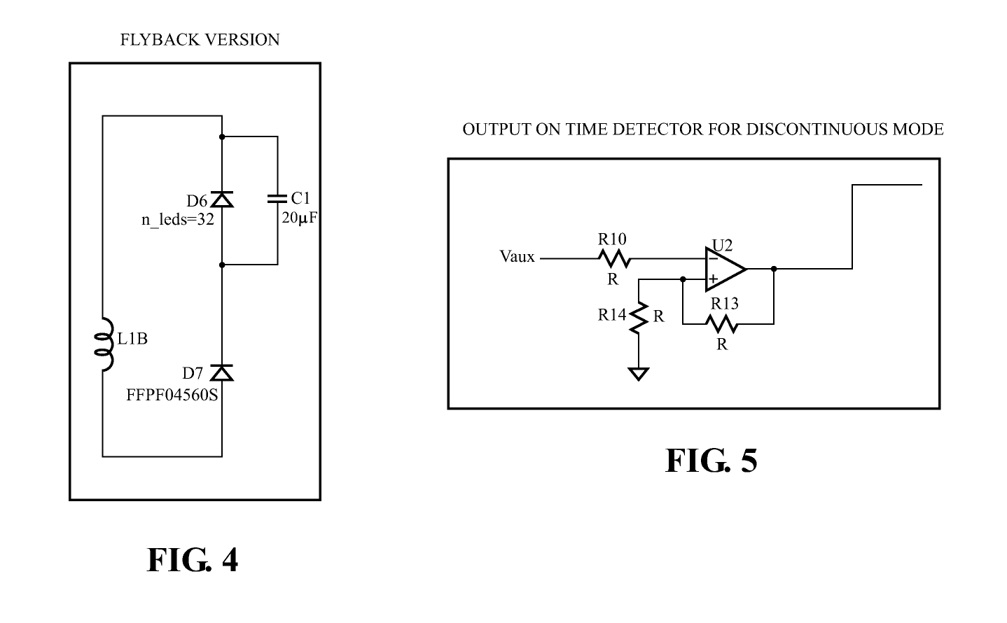

As indicated above, the circuit 18 is a buck-boost circuit which produces a smooth current profile. But the circuit also operates equally well with a flyback circuit as shown in FIG. 4, it being understood that circuit of FIG. 4 can be substituted for the buck-boost circuit comprising D6 and C1 as well as D1 shown in FIG. 1.

Similarly, FIG. 1 shows the circuit operating in a boundary conduction mode but the principles of the present invention also apply if the circuit operates in a discontinuous conduction mode. FIG. 5 illustrates the circuit componentry of circuit 14 for the discontinuous mode of operation. The “duty cycle” then becomes the proportion of the output conduction time to the signal repetition period; i.e., excluding the time between the end of the output conduction time and the start of the next switch on time. The input of the circuit in FIG. 5 is connected to Vaux, and the output to the control terminal of the SPDT switch (A). Circuit 101 in FIG. 1 is an optional combined amplifier and output current level setting circuit. It provides non-inverting amplification of the feedback signal. The potentiometer sets the output current level by varying the amplification of the feedback signal.

Summarizing, the circuit described herein provides an apparatus and method for determining and regulating the output current of a buck-boost or flyback power supply in discontinuous or boundary conduction mode using only peak current and a signal corresponding to the output conduction duty cycle to infer the average output current of the regulator or controller 12. This eliminates high side current sensing, opto-isolators and/or photodetectors located adjacent to LEDs to sense or otherwise produce a signal related to output light intensity for use as a feedback signal. The circuit is especially useful for circuits which need electrical isolation between input and output since no information needs to be transmitted between the output and the input side of the circuit.

In all cases, the average output current is proportional to the average current during the output conduction time and zero during the output non-conduction time, weighted by the output conduction time and the output non-conduction time, respectively. If a signal is generated as proportional in amplitude to the peak input current and that signal is gated on during the output conduction time but gated to zero during the output non-conduction time, that signal can be and is low-pass filtered to generate a signal that over time has an average value proportional to output current as shown in FIG. 3E. The peak input current can be used because for a triangular waveform, the average current is proportional to the peak.

For boundary conduction mode devices, the output conduction time can be determined from the off time of the switch since as soon as the output current reaches zero the switch is turned back on. For discontinuous regulator operation, the output conduction can be determined from the secondary winding on the main inductor that reflects a positive voltage during the output conduction time and a negative voltage for near zero during the output non-conduction time.

It is to be understood that various modifications and additions to the circuit shown and described herein can be made and that the specific circuitries and component values are illustrative rather than limiting.

What is claimed is:

1. A method of controlling the output of a regulator feeding current to an LED-based light to produce a relatively constant light output comprising the steps of:
a. determining the peak input current to the regulator and the conduction duty time of the regulator;
b. constructing a signal based on the results of the foregoing step; and
c. using the signal in a feedback mode to control regulator output.

2. Apparatus for controlling the light output of an LED-based light to produce a relatively constant light output comprising:
a regulator having a duty cycle and a line-voltage-related input current, and connected to feed current to the light;
a sample and hold circuit for producing a signal related to the peak input current to the regulator and the conduction duty cycle of the regulator; and
a feedback circuit connecting said signal to an input of the regulator.

3. An LED light comprising:
at least one LED;
an input current circuit;
a switch-type regulator circuit having a duty cycle and being connected to said one LED;
an output inference circuit operable in a sample and hold mode and producing a signal related to peak regulator input current and the regulator circuit duty cycle; and
a feedback circuit connecting said signal to an input of the regulator.

4. An LED light as defined in claim 3 wherein the output inference circuit is a buck-boost circuit.

5. An LED light as defined in claim 3 wherein the output inference circuit is a flyback circuit.

6. An LED light as defined in claim 3 wherein the regulator circuit includes a switching inductor.
